(19) United States
(12) Patent Application Publication
(10) Pub. No.: US 2006/0151566 A1
(43) Pub. Date: Jul. 13, 2006

(54) Cassette type stapler

(76) Inventor: Yoshiyuki Ebihara, Tokyo (JP)

Correspondence Address: GRIMES & BATTERSBY, LLP, 488 MAIN AVENUE, THIRD FLOOR, NORWALK, CT, 06851, US

(21) Appl. No.: 10/516,124

(22) PCT Filed: May 28, 2003
(86) PCT No.: PCT/JP03/06709

§ 371 Date: Nov. 29, 2004

(30) Foreign Application Priority Data
May 28, 2002 (JP) 2002-154342

(51) Int. Cl. B25C 5/06

(52) U.S. Cl. 227/134; 227/120

(57) ABSTRACT

A large cassette type stapler allowing, with a simple structure, a locking means for fixing a cassette mounting position to be installed on the rear end lower surface of a cassette, comprising a locking means (15) having a spring (14) for energizing the cassette in extracting direction which is fitted to the rear end of the cassette, a locking projected part (16) provided on the rear end lower surface of the cassette (5), and a hook (21) capable of being automatically locked to the locking projected part (16) when upwardly rotated by the energization of a spring (22) installed on a base (1) side opposed to the locking projected part and unlocked by manually pushing down.

### TECHNICAL FIELD

The present invention relates to a large-sized cassette type stapler for loading a cassette stored with staples and, more particularly, to locking means for the cassette.

### BACKGROUND ART

As the cassette type stapler of the prior art, there has been known the inventions which are disclosed in JP-KOKAI (Unexamined Patent Publication)-SHO63-84881 and JP-KOKOKU (Examined Patent Publication)-HEI3-25308.

Both of these inventions disclosed are directed to a small-sized stapler. A cassette formed to have a rectangular cylinder shape is stored with staples, and is loaded into a cylindrical cassette holder, so that the staples may be shot with the blade disposed at the leading end portion of a handle which is turned on the rear end of a base. Locking means for fixing the loading position of the cassette holder is constructed such that a locking projection is inserted into and extracted out of a locking hole formed in the cassette through a locking hole formed in the upper face or the lower face of the cassette holder.

The stapler of the prior art thus far described is of a small size to have a relatively small stapling thickness so that it does not require a strong force. The large-sized stapler according to the invention is provided with a frame to be turned with respect to the base face. There has never been developed locking means for locking and unlocking the cassette into and out of the frame.

### DISCLOSURE OF THE INVENTION

Therefore, the invention has been conceived in view of the problems of the prior art thus far described, and has an object to provide a large-sized stapler which is equipped with the locking means having a simple construction on the lower face of the rear end of the cassette.

In order to achieve the above-specified object, according to Claim 1 of the invention, there is provided a cassette type stapler, wherein a frame for mounting the cassette of the cassette type stapler having a locking projection on the lower face portion of an insertion leading end is provided with a cover portion having a cassette guide portion, wherein an operating portion having a lever biased upward on a fulcrum by a spring is arranged below the rear end of the cassette guide portion, wherein a locking projection for locking the projection of the lower face portion of the cassette is formed on the upper face of the lever, and wherein an elastic member for biasing the cassette in an extracting direction is arranged at the rear end of the cassette guide portion, characterized in that the lever is turned by pushing down the operating portion biased by the elastic member, to release the locking projection of the lever from the locking state, in which the locking projection of the cassette is automatically locked.

According to the invention of Claim 2, the cassette type stapler is characterized in that the operating portion is vertically turned on the fulcrum by the energization of the elastic member and is provided with the locking projection on its upper face for being brought into and out of engagement with the locking projection at the lower end of the cassette by the vertical movements by the energization of the elastic member, and in that those components are integrally made of a hard synthetic resin.

According to the inventions of Claims 3 to 5, the frame portion and the cover portion, the frame and the cap portion, and the frame, the cover portion and the cap portion are made of a hard synthetic resin respectively.

According to the invention of Claim 11, the engagement between the frame and the cassette is caused by a stopper, whereby the cassette is temporarily prevented from popping out from the frame by the engagement of the stopper when the locking projection of the lever is released from the locking state, in which the locking projection of the cassette is automatically locked.

In the cassette type stapler of the invention, according to Claim 1, the loading position can be fixed merely by inserting the cassette into the frame, and the locking state of the locking projection can be released merely by pushing the lever of the operating portion downward. At this time, the cassette can be extracted while being popped out by the energization of the elastic member (or spring). The locking means is made so compact as to permit the loading of the cassette with the simple construction.

According to Claim 2, the hook is made of the plastics so that the locking means can be constructed at a low cost.

According to Claims 3 to 5, the frame and the cover portion, the frame and the cap portion, and the frame, the cover portion and the cap portion are integrally formed so that the number of parts can be reduced to construct the stapler at a low cost.

According to the invention of Claim 6, moreover, there is provided a cassette type stapler for driving staples by the vertical movements of a blade, wherein the blade has a blade holder only at its upper portion, wherein an auxiliary guide is formed over the cap for supporting the blade, wherein a frame for mounting the cassette of the cassette type stapler having a locking projection on the lower face portion of an insertion leading end is provided with a cover portion having a cassette guide portion, wherein an operating portion having a lever biased upward on a fulcrum by a spring is arranged below the rear end of the cassette guide portion, wherein a locking projection for locking the projection of the lower face portion of the cassette is formed on the upper face of the lever, and wherein an elastic member for biasing the cassette in an extracting direction is arranged at the rear end of the cassette guide portion, characterized in that the lever is turned by pushing down the operating portion biased by the elastic member, to release the locking projection of the lever from the locking state, in which the locking projection of the cassette is automatically locked.

According to the invention of Claim 7, the cassette type stapler is characterized: in that the operating portion is vertically turned on the fulcrum by the energization of the elastic member and is provided with the locking projection on its upper face for being brought into and out of engagement with the locking projection at the lower end of the cassette by the vertical movements by the energization of the elastic member; and in that those components are integrally made of a hard synthetic resin.

In the inventions of Claims 8 to 10, the cassette type stapler is characterized in that the frame portion and the cover portion, the frame and the cap portion, and the frame, the cover portion and the cap portion are made of a hard synthetic resin respectively.

In the cassette type stapler of the invention, according to Claim 6, the cassette can be easily incorporated into the frame by reducing the blade holder 6. Moreover, the loading position can be fixed merely by inserting the cassette into the frame, and the locking state of the locking projection can be released merely by pushing the lever of the operating portion downward. At this time, the cassette can be extracted while being popped out by the energization of the elastic member (or spring). The locking means is made so compact as to permit the loading of the cassette with the simple construction.

According to Claim 7, the hook is made of the plastics so that the locking means can be constructed at a low cost.

According to Claims 8 to 10, the frame and the cover portion, the frame and the cap portion, and the frame, the cover portion and the cap portion are integrally formed so that the number of parts can be reduced to construct the stapler at a low cost.

The invention according to Claim 11 is characterized by establishing the locking state by the stopper in addition to the ordinary one. When the ordinary locking state (or the first locking state) is released, the locking state (or the second locking state) by the stopper functions to prevent the cassette temporarily from being vigorously popped out forward. This second locking state has to be a temporary one. In short, there is needed means for releasing the second locking state easily thereby to remove the cassette completely from the stapler body.

### BRIEF DESCRIPTION OF THE DRAWINGS

FIG. 1 is a sectional view showing an essential portion of the side face of a stapler according to an embodiment of the invention.

FIG. 2 is a sectional view of an essential portion and shows the action of locking means.

FIG. 3 is a side elevation of a stapler showing the loading/unloading of a cassette.

FIG. 4 is a side elevation of the stapler showing the loading/unloading of the cassette.

FIG. 5 is a view showing the front end face of the stapler.

FIG. 6 is a view showing the rear end face of the stapler.

FIG. 7 is a sectional view showing an essential portion of a hook formed integrally with a hook spring.

FIG. 8 is a sectional view of an essential portion and shows the action of the hook.

FIG. 9 is a sectional view showing an essential portion of the relation between a blade holder and a blade of Embodiment 3.

FIG. 10 is an enlarged view showing an essential portion of the blade holder and the blade shown in FIG. 9.

FIG. 11 is a sectional view of an essential portion and shows the action of a hook of Embodiment 4.

FIG. 12 is a sectional view of an essential portion and shows the action of the hook of Embodiment 4.

### BEST MODE FOR CARRYING OUT THE INVENTION

### Embodiment 1

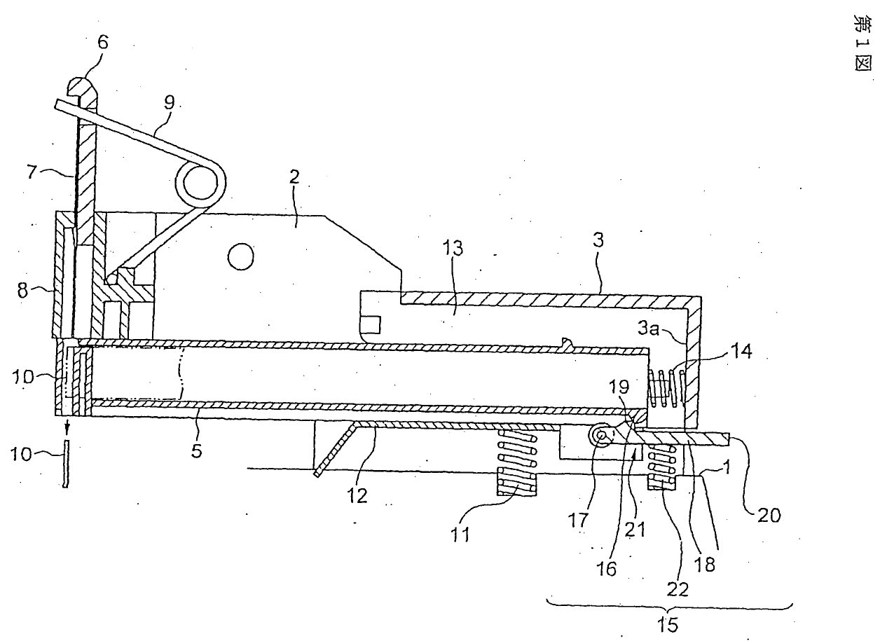

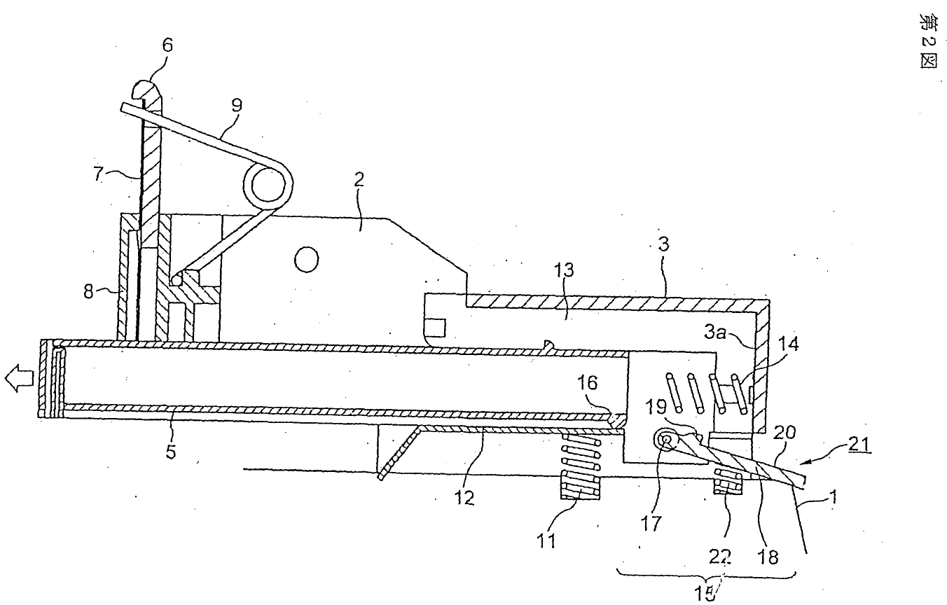

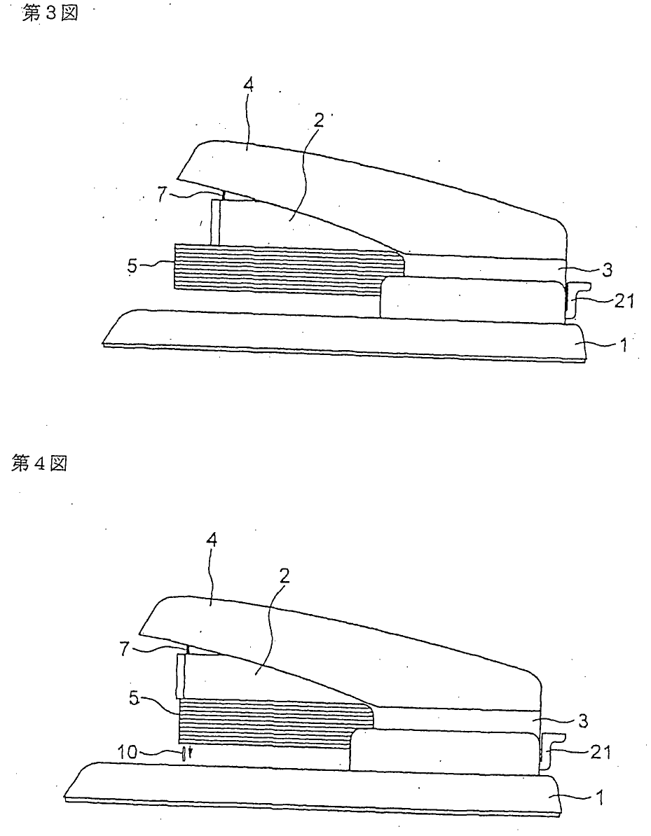

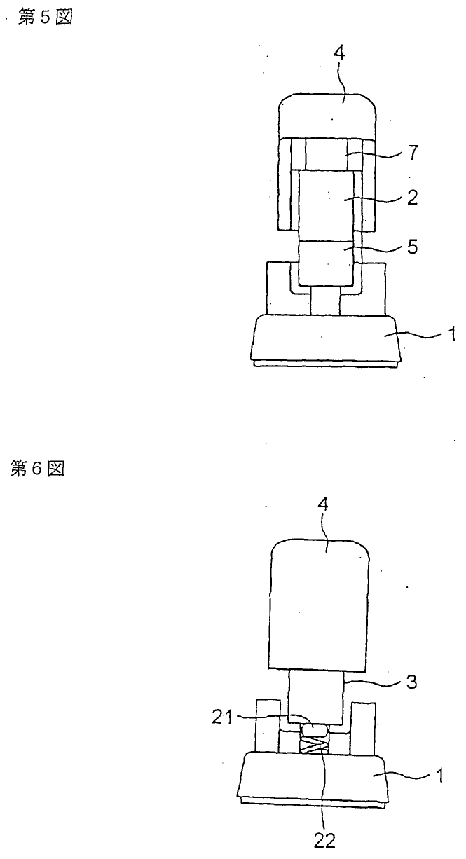

FIG. 1 to FIG. 6 show Embodiment 1 of the invention. FIG. 1 is a sectional view of an essential portion of the side face of a stapler; FIG. 2 is a sectional view of an essential portion and shows the action of locking means; FIG. 3 and FIG. 4 are side elevations of a stapler for loading/unloading a cassette; FIG. 5 is a view showing the front end face of the stapler; and FIG. 6 is a view showing the rear end face of the stapler.

As shown in FIG. 4, the stapler according to the invention is constructed to include as major components: a base 1; a frame 2 capable of turning on the rear end portion of the base 1; a cassette 5 loaded on the frame 2; a cover portion 3 disposed at the rear end portion of the frame 2; and a handle 4 capable of turning on the rear end portion of the base over the frame 2, so that it may lower a blade 7 mounted vertically movably in the frame 2 thereby to shoot staples 10 stored in the cassette 5.

In FIG. 1 showing the detail of the stapler, moreover, there is fixed to the leading end portion of the frame 2 a cap 8 for guiding the blade 7 fixed to a blade holder 6. Moreover, the blade 7 is lowered, as the upper end of the blade holder 6 is pushed by the handle 4 shown in FIG. 4, to shoot the staple 10 in the cassette 5, and is then raised by the energization of a spring 9. Of the frame 2 and the cover 3 and the cap 8: especially the frame 2 and the cover 3; the frame 2 and the cap 8; and the frame 2, the cover 3 and the cap 8 can be integrally made of a hard synthetic resin respectively. As a result, the number of parts can be reduced to lower the cost.

As shown in FIG. 1, the key-shaped cover 3 is disposed on the back of the frame 2, and a base spring 11 is disposed on the face of the base 1 so that the lower face of the cassette 5 is pushed upward through a guide plate 12 by that base spring 11. As a result, the cassette 5 is inserted between the lower face of a guide portion 13 of the cover 3 and the guide plate 12 so that the cassette 5 is loaded without any rattling by the pushing force of the base spring 11.

Moreover, the rear end face of the cassette 5 is biased at all times in the direction to be pushed out by a coil-shaped push spring 14 or an elastic member between that rear end face and the key-shaped wall face 3a of the cover 3. On the lower face of the rear end of the cassette 5, moreover, there is disposed locking means 15 for fixing the loading position of the cassette 5.

Specifically, the locking means 15 is constructed to include: a locking projected portion 16 formed at the rear end of the cassette 5; a hook 21 formed of plastics to have a lever 18 disposed on the frame side to correspond to the locking projected portion 16 and made turnable on a fulcrum 17, a locking projection 19 formed on the upper face near the fulcrum 17 for being locking by the locking projected portion 16, and an operating portion 20 with the lever 18 extending from the cover 3 to the outside; and a hook spring 22 disposed on the face of the base 1 for pushing the hook 21 upward, i.e., toward the locking projected portion 16.

Thus, as the lever 18 of the hook 21 is manually pushed down, the locking projection 19 is unlocked from the locking projected portion 16, as shown in FIG. 2, so that the cassette 5 is pushed out by the push spring 14 at the rear end.

According to this embodiment, the locking means has such simple construction, and the hook 21 is always pushed up by the hook spring 22. Merely by pushing the cassette 5 into the frame 2, therefore, the locking projected portion 16 and the locking projection 19 are automatically brought into engagement so that the loading position is fixed. The locking state by the locking means 15 is released merely by pushing the lever of the hook 21 manually downward, so that the cassette can be automatically pushed out by the push spring and can be removed.

### Embodiment 2

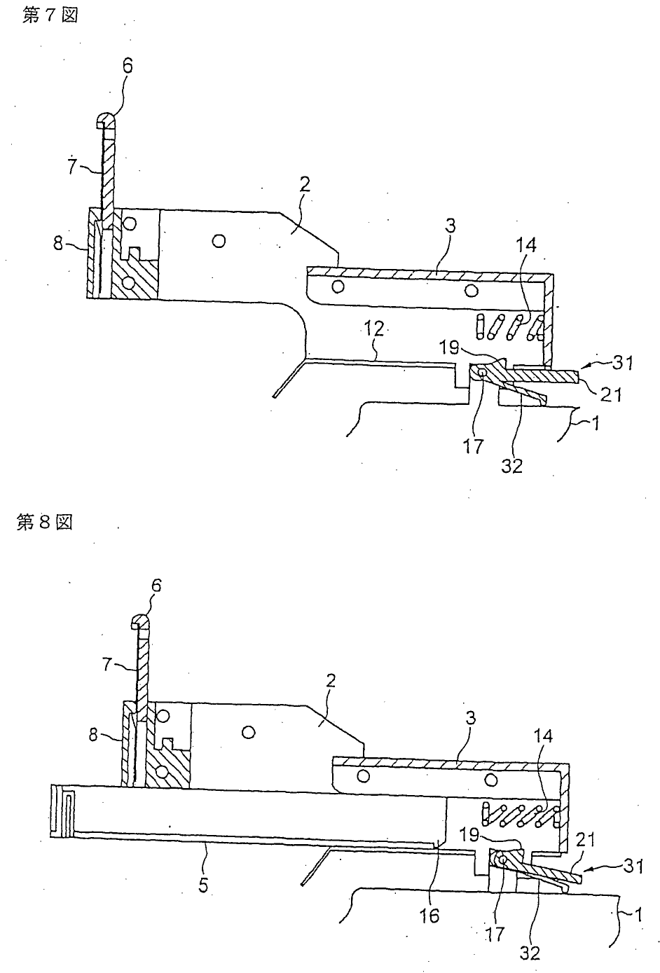

FIG. 7 and FIG. 8 are presented for explaining Embodiment 2 of the invention. FIG. 7 is a sectional view showing an essential portion of the hook formed integrally with a hook spring, and FIG. 8 is a sectional view of an essential portion and shows the action of the hook.

This embodiment is different from Embodiment 1 in which the hook spring for pushing the hook 21 upward is made separate, in that the hook and the hook spring are integrally formed of plastics. The remaining constructions are similar to those of Embodiment 1, and the description of the common components will be omitted by designating the components by the common reference numerals.

In this embodiment, a hook 31 is made integral with a leaf spring portion 32 inclined downward and formed on the lower face near the turning fulcrum 17 of the hook 21 in Embodiment 1. The leaf spring portion 32 has its open end mounted elastically on the face of the base 1.

When this hook 31 is pushed downward, as shown in FIG. 8, the leaf spring portion 32 is elastically deformed so that the hook 31 can turn to unlock the cassette 5. Thus, it is possible to attain actions and effects like those of Embodiment 1.

### Embodiment 3

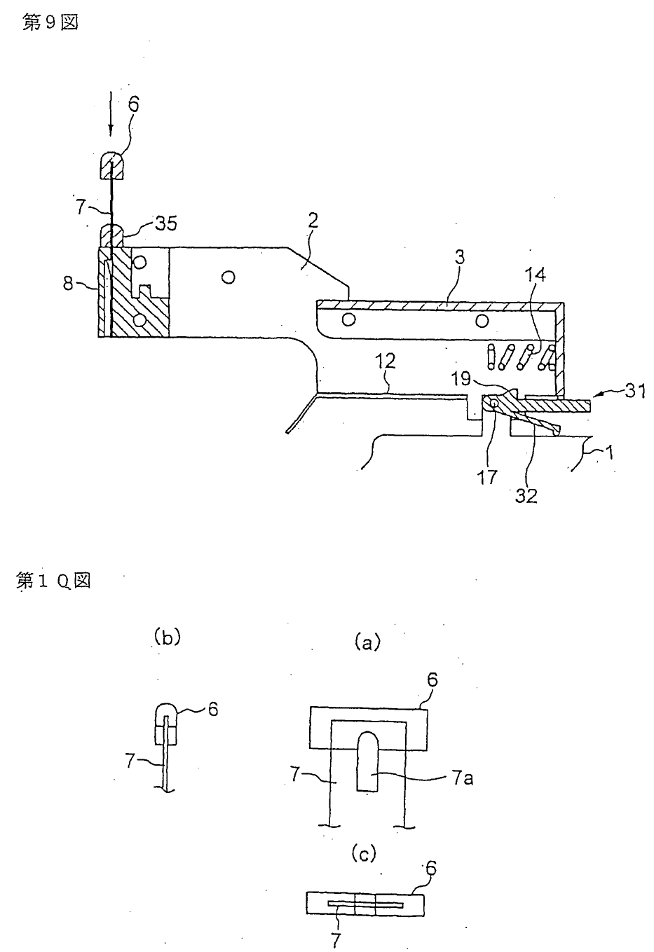

FIG. 9 and FIG. 10 show Embodiment 3 of the invention. FIG. 9 is a sectional view of an essential portion and shows a structure of the blade holder 6 and the blade 7, and FIG. 10 presents enlarged views showing the details of the blade holder 6 and the blade 7.

In the stapler of Embodiment 3, as shown in FIG. 9, the cap 8 is fixed to the leading end portion of the frame 2, and the blade 7 held by the blade holder 6 is guided by the cap 8 when it moves up and down. The blade holder 6 is formed only at the crest of the blade 7. Moreover, an auxiliary guide 35 is formed over the cap 8.

As shown in FIG. 10, the blade holder 6 is made wider than the blade 7. A hole 7a for locking the spring 9 is formed in the blade 7.

This blade 7 is moved down, as the upper end of the blade holder 6 is pushed at its upper end by the handle 4 shown in FIG. 4, to shoot the staples 10 in the cassette 5, and is then moved up by the energization of the spring 9.

By thus reducing the blade holder 6 is size, the incorporation into the frame 2 can be easily performed, and can be manufactured at a low cost.

### Embodiment 4

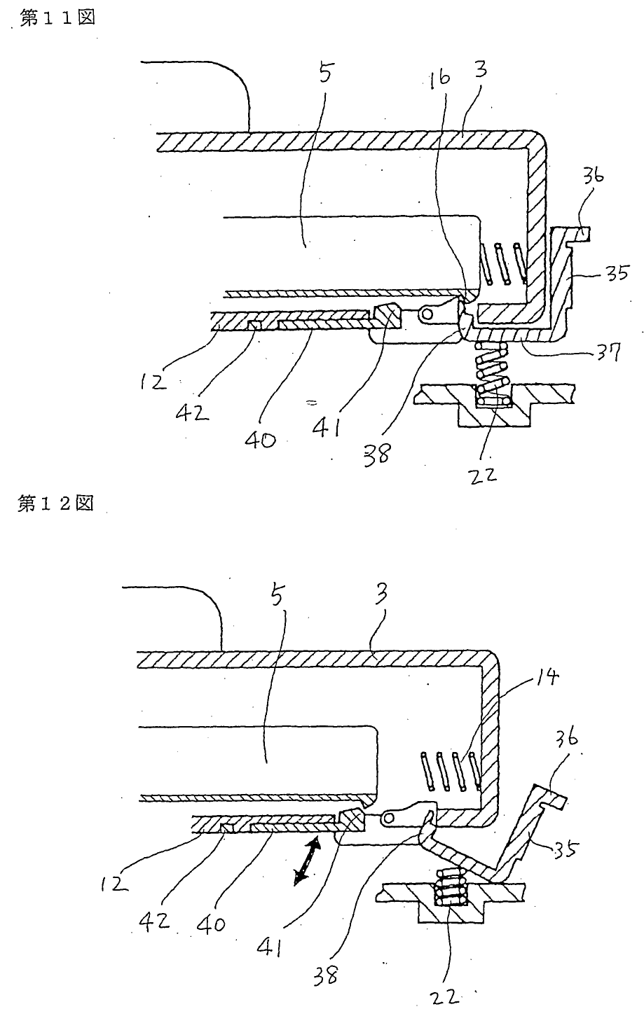

FIG. 11 and FIG. 12 relating to Embodiment 4 are sectional views of an essential portion and show the action of the hook.

This embodiment is characterized by providing a stopper 40.

As shown, the hook 35 includes an operating portion 36 and a locking portion 38, and is arranged such that the operating portion 36 is positioned outside of the rear end of the cover 3 whereas the locking portion 38 is positioned inside of the rear end of the cover 3. The hook spring 22 is disposed below the bottom portion 37 of the hook, and applies a force in the direction to keep the hook 35 at a position shown in FIG. 11. The stopper 40 is mounted at its root portion 41 on the bottom portion of the guide blade 12. A stopper free end 41 can finely move on the stopper root portion 41 in the direction, as indicated by arrows in FIG. 12, when the stopper itself is warped by a downward small force.

When the cassette 5 is to be loaded into the cover portion 3, as shown in FIG. 11, the locking portion 16 of the cassette abuts against the hook 35 so that the locking portion 38 of the hook is fitted into the locking projected portion 16 by the elastic force of the hook spring 22 thereby to position the cassette 5 with respect to the frame (FIG. 8). When the cassette 7 is to be unloaded, as shown in FIG. 12, the operating portion 36 of the hook is pushed down against the hook spring 22 to unlock the engagement between the locking portion 38 of the hook and the locking projected portion 16 of the cassette. Then, the cassette 5 is popped forward by the elasticity or the like of the push spring 14. At this time, the cassette is prevented from popping out (FIG. 12) by the engagement of the locking projected portion 16 of the cassette 5 with the free end 41 of the stopper 40. After this, the cassette 5 is gripped and pulled forward, the engagement between the locking projected portion 16 and the hook 35 is easily released by the vertical fine movements of the stopper free end 41 so that the cassette can be extracted.

### INDUSTRIAL APPLICABILITY

According to the invention, the hook as the cassette locking means for locking the lower face of the rear end of the cassette is made turnable so that the locking means can be made compact with a simple construction. As a result, it is possible to manufacture the cassette type stapler at a low cost.

### EXPLANATION OF LETTERS OR NUMERALS

1. Base

2. Frame

3. Cover

4. Handle

5. Cassette

6. Blade holder

7. Blade

8. Cap

9. Spring

10. Staple

11. Base spring

12. Guide plate

13. Guide portion

14. Push spring

15. Locking means

16. Locking projected portion

17. Fulcrum

18. Lever

19. Locking projection

20. Operating portion

21. Hook

22. Hook spring

31. Hook

32. Leaf spring portion

35. Hook

36. Operating portion

37. Bottom portion

38. Locking portion

40. Stopper

41. Stopper free end

42. Stopper root portion

1. A cassette type stapler for driving staples by the vertical movements of a blade, wherein a frame for mounting the cassette of the cassette type stapler having a locking projection on the lower face portion of an insertion leading end is provided with a cover portion having a cassette guide portion, wherein an operating portion having a l\ever biased upward on a fulcrum by a spring is arranged below the rear end of said cassette guide portion, wherein a locking projection for locking the projection of the lower face portion of said cassette is formed on the upper face of said lever, and wherein an elastic member for biasing said cassette in an extracting direction is arranged at the rear end of said cassette guide portion,
characterized in that said lever is turned by pushing down said operating portion biased by said elastic member, to release the locking projection of said lever from the locking state, in which the locking projection of said cassette is automatically locked.

2. A cassette type stapler as set forth in claim 1,
characterized in that said operating portion is vertically turned on the fulcrum by the energization of the elastic member and is provided with the locking projection on its upper face for being brought into and out of engagement with said locking projection at the lower end of the cassette by the vertical movements by the energization of said elastic member, and in that those components are integrally made of a hard synthetic resin.

3. A cassette type stapler as set forth in claim 1 or 2, characterized in that said frame portion and said cover portion are made of a hard synthetic resin.

4. A cassette type stapler as set forth in claim 1 or 2, characterized in that said frame portion and said cap portion are made of a hard synthetic resin.

5. A cassette type stapler as set forth in claim 1 or 2, characterized in that said frame portion, said cover portion and said cap portion are made of a hard synthetic resin.

6. A cassette type stapler for driving staples by the vertical movements of a blade, wherein said blade has a blade holder only at its upper portion, wherein an auxiliary guide is formed over the cap for supporting the blade, wherein a frame for mounting the cassette of the cassette type stapler having a locking projection on the lower face portion of an insertion leading end is provided with a cover portion having a cassette guide portion, wherein an operating portion having a lever biased upward on a fulcrum by a spring is arranged below the rear end of said cassette guide portion, wherein a locking projection for locking the projection of the lower face portion of said cassette is formed on the upper face of said lever, and wherein an elastic member for biasing said cassette in an extracting direction is arranged at the rear end of said cassette guide portion,
characterized in that said lever is turned by pushing down said operating portion biased by said elastic member, to release the locking projection of said lever from the locking state, in which the locking projection of said cassette is automatically locked.

7. A cassette type stapler as set forth in claim 6, characterized: in that said operating portion is vertically turned on the fulcrum by the energization of the elastic member and is provided with the locking projection on its upper face for being brought into and out of engagement with said locking projection at the lower end of the cassette by the vertical movements by the energization of said elastic member; and in that those components are integrally made of a hard synthetic resin.

8. A cassette type stapler as set forth in claim 6 or 7, characterized in that said frame portion and said cover portion are made of a hard synthetic resin.

9. A cassette type stapler as set forth in claim 6 or 7, characterized in that said frame portion and said cap portion are made of a hard synthetic resin.

10. A cassette type stapler as set forth in claim 6 or 7, characterized in that said frame portion, said cover portion and said cap portion are made of a hard synthetic resin.

11. A cassette type stapler as set forth in claim 1, characterized in that the engagement between said frame and said cassette is caused by a stopper, whereby the cassette is temporarily prevented from popping out from the frame by the engagement of the stopper when the locking projection of said lever is released from the locking state, in which the locking projection of said cassette is automatically locked.
